(19) United States
(12) Patent Application Publication
(10) Pub. No.: US 2015/0028558 A1
(43) Pub. Date: Jan. 29, 2015

(54) WHEELCHAIR BOWLING KIT

(71) Applicants: Richard Shane Hartman, Walden, CO (US); Jack Samuel Horox, Walden, CO (US)

(72) Inventors: Richard Shane Hartman, Walden, CO (US); Jack Samuel Horox, Walden, CO (US)

(21) Appl. No.: 14/340,056

(22) Filed: Jul. 24, 2014

Related U.S. Application Data
(60) Provisional application No. 61/858,065, filed on Jul. 24, 2013.

(51) Int. Cl. A61G 5/02

(52) U.S. Cl. CPC A61G 5/026; A61G 5/022
USPC 280/250; 474/148

(57) ABSTRACT

A wheelchair bowling kit and bowling wheelchair are described. Embodiments of the wheelchair bowling kit can be implemented to allow a handicapped bowler to bowl more conventionally. Generally, the wheelchair bowling kit can include a drive mechanism and a locking mechanism. The drive mechanism can be implemented to propel a wheelchair forward using only one hand while the other hand is free to hold a bowling ball. The locking mechanism can be included to keep a castor of the wheelchair from rotating, resulting in the wheelchair moving in a substantially straight line. The bowling wheelchair can include components similar to the drive mechanism and locking mechanism that are manufactured as part of the bowling wheelchair.

### CROSS-REFERENCE TO RELATED APPLICATION

This application claims the benefit of U.S. Provisional Application No. 61/858,065, filed Jul. 24, 2013.

### BACKGROUND

Currently, wheelchair-bound bowlers have difficulty bowling because two hands are needed to propel a wheelchair. Usually, when attempting to propel a wheelchair forward using only a single hand, the chair takes a circular path rather than a straight line path. Further, the placement of main wheels including handrims typically interferes with swinging the ball in a straight line. The handrims, which are implemented for a user to rotate the wheels, protrude out from the wheels and interfere with the user swinging a bowling ball. As such, users are required to have a curved swing further increasing the difficulty and frustration of bowling while using a wheelchair. Alternatively, wheelchair-bound bowlers are required to use ramps which take away basic elements of the bowling experience.

A wheelchair bowling kit and/or wheelchair specifically designed for bowling is needed.

### BRIEF DESCRIPTION OF THE DRAWINGS

FIG. 1A is a perspective view of a wheelchair bowling kit according to one embodiment of the present invention.

FIG. 1B is a perspective view of a wheelchair bowling kit according to one embodiment of the present invention.

FIG. 2 is a side view of a drive mechanism of the wheelchair bowling kit according to one embodiment of the present invention.

FIG. 3A is a side view of a locking mechanism of the wheelchair bowling kit according to one embodiment of the present invention.

FIG. 3B is a close-up view of a locking mechanism of the wheelchair bowling kit according to one embodiment of the present invention

FIG. 4A is a perspective view of a bowling wheelchair according to one embodiment of the present invention.

FIG. 4B is a perspective view of a bowling wheelchair according to one embodiment of the present invention.

### DETAILED DESCRIPTION

Embodiments of the present invention include a wheelchair bowling kit having a drive mechanism and a locking mechanism. Generally, the kit can be retrofitted to a wheelchair. The drive mechanism can generally be implemented to allow a user to propel the wheelchair with one hand and hold a bowling ball in the other hand. The locking mechanism can be implemented to lock a castor in a substantially straight position so that the wheelchair travels in a straight line when the locking mechanism is engaged.

In one embodiment, the drive mechanism can include a first sprocket, a second sprocket, a chain, a crank, and an extension rod. Generally, the first sprocket can be located on an axle with one of the wheels of the wheelchair. The second sprocket can be coupled to the extension rod near a top portion of the extension rod. The chain can be implemented to couple the first sprocket to the second sprocket. The crank can be coupled to the second sprocket. In a typical implementation, a user can use the crank to rotate the second sprocket, which is mechanically coupled to the first sprocket, and rotates the first sprocket which is mechanically coupled to the axle of the wheelchair. By rotating the crank, the user can propel the wheelchair with one arm.

The drive mechanism can generally be placed on a side of the wheelchair corresponding to a non-dominant hand of a user. For instance, for a right-handed bowler, the drive mechanism may be located on a left side of the wheelchair so that the crank can be operated by a left hand of a bowler. The bowler may then use their dominant hand to swing a bowling ball. In some embodiments, a rear wheel located on an opposite side of the drive mechanism may be located closer to the body of the wheelchair. In such an embodiment, the user may be able to more easily swing their arm in a straight line, rather than a curved path.

Typically, the locking mechanism can include a first lever, a plate, a second lever, and a spring. Depending on an implementation, the locking mechanism can be adapted to fit on either side of the wheelchair. Generally, the locking mechanism can be located on an opposite side of the wheelchair from the drive mechanism. The locking mechanism can be operated by one hand of the user to ensure the wheelchair travels in a substantially straight line.

In a typical implementation, the drive mechanism and the locking mechanism can be fitted to a wheelchair. Depending on the type of wheelchair, handrims attached to wheels of the wheelchair can be removed. In one embodiment, a wheel on a side opposite to a side the drive mechanism is to be attached to, can be moved in closer to a frame of the wheelchair. For instance, most wheelchairs include one or more spacers between the wheel and frame of the wheelchair. The spacers can be removed to move the wheel in closer to the frame of the wheelchair. After the mechanisms are fitted, a user can proceed to bowl. Generally, the user can make sure a castor is locked in a straight position by engaging the locking mechanism. Once the locking mechanism is engaged, the user can rotate the crank to drive the wheelchair forward. Using only one hand to drive the wheelchair forward, the user can use the other hand to carry and swing a bowling ball.

Embodiments of the present invention further include a bowling wheelchair. The bowling wheelchair can include components similar to the drive mechanism and locking mechanism of the wheelchair bowling kit. Generally, the bowling wheelchair can more permanently implement components similar to the drive mechanism and the locking mechanism into construction of the wheelchair. For instance, components similar to the drive mechanism and locking mechanism can be engineered into the design of a wheelchair.

### Terminology

The terms and phrases as indicated in quotation marks (“ ”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

### An Embodiment of a Wheelchair Bowling Kit

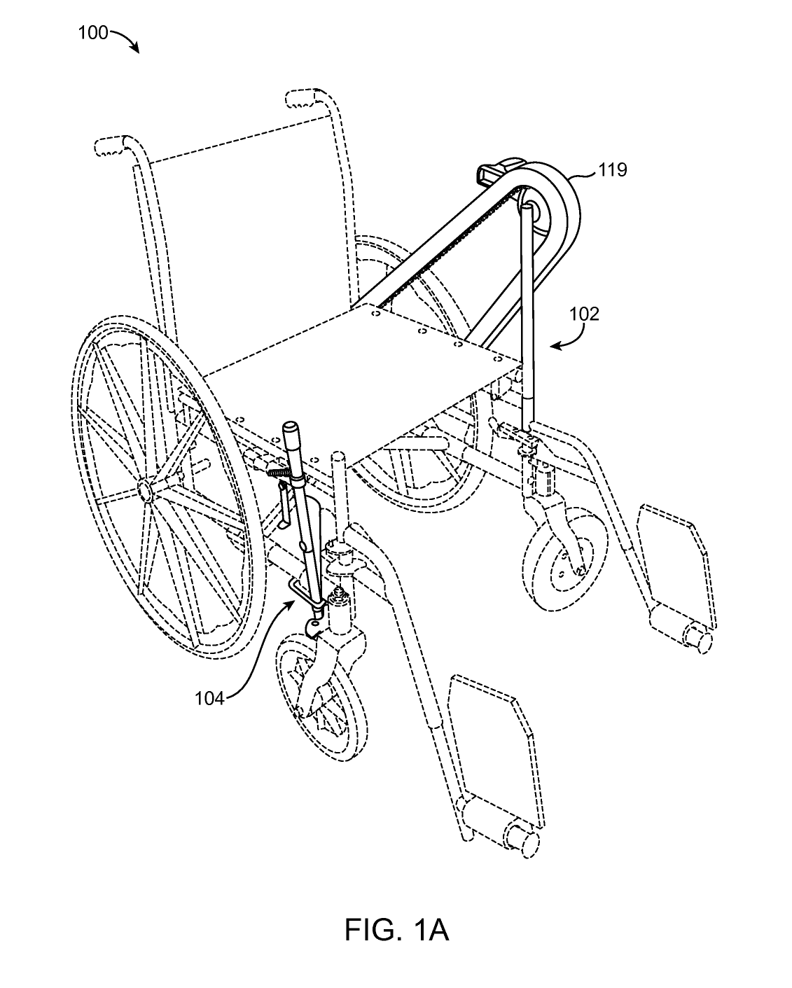

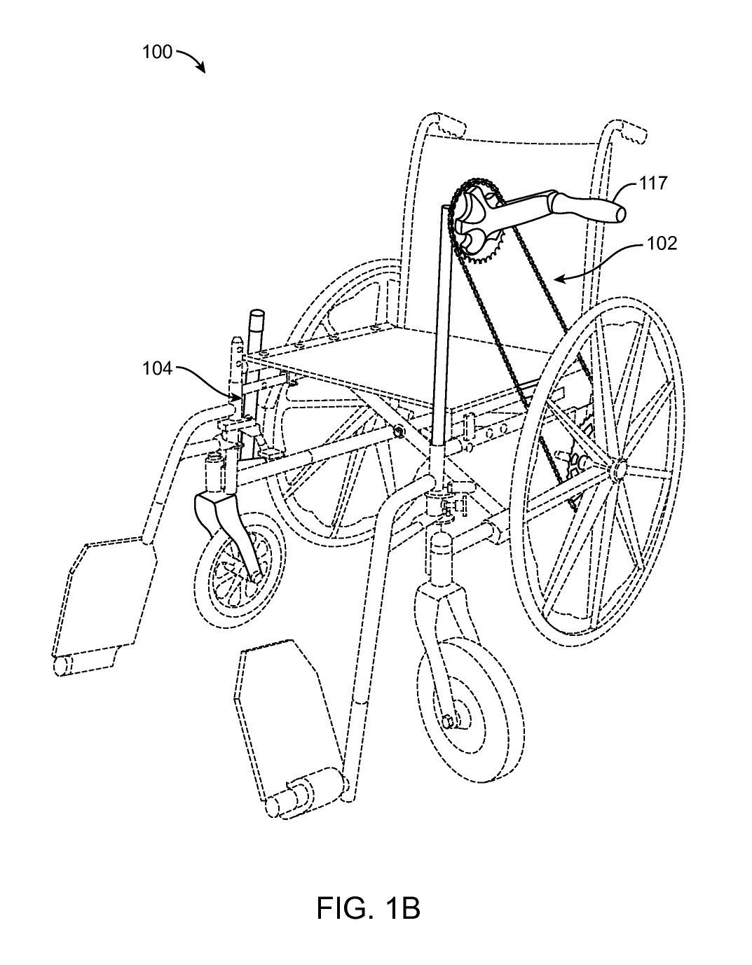

Referring to FIGS. 1A and 1B, a detailed diagram of an embodiment 100 showing a wheelchair bowling kit implemented with a wheelchair is illustrated. In one embodiment, the wheelchair bowling kit 100 can be implemented for handicapped bowlers to allow them to bowl more conventionally. It is to be appreciated that the wheelchair bowling kit 100 can be implemented for other activities and/or sports where a user needs a free hand while propelling a wheelchair forward and backward.

Generally, the wheelchair bowling kit 100 can include a drive mechanism 102, as shown generally in FIG. 1B, and a locking mechanism 104, as shown generally in FIG. 1A. The drive mechanism 102 can be implemented to allow a user to propel the wheelchair with one hand and the locking mechanism 104 can be implemented to move the wheelchair in a substantially straight line. As shown, the drive mechanism 102 can be located on a left side of the wheelchair and the locking mechanism 104 on the right side of the wheelchair. It is to be appreciated that the mechanisms 102, 104 can be implemented on either side of the wheelchair depending on which hand the user bowls with. In one embodiment, only one of the mechanisms 102, 104 may be implemented. For instance, the drive mechanism 102 may be implemented while the locking mechanism 104 is not.

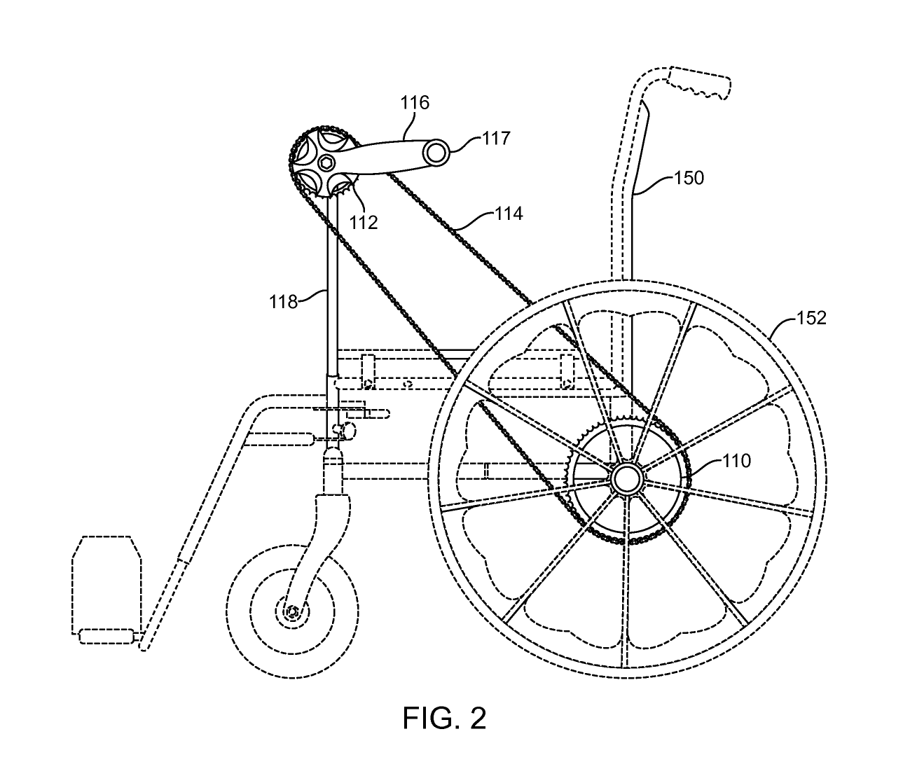

Referring to FIG. 2, a detailed diagram of the drive mechanism 102 is illustrated. Generally, the drive mechanism 102 can include a first sprocket 110, a second sprocket 112, a chain 114, a crank 116, and an extension rod 118.

In one embodiment, the drive mechanism 102 can be coupled to a left side of the wheelchair 150. It is to be appreciated that the drive mechanism 102 can be implemented on either the right or left side of the wheelchair 150.

As shown in FIG. 2, the first sprocket 110 can be coupled to an inner side of a wheel assembly 152 of the wheelchair 150. For instance, the first sprocket 110 can be adapted to fit onto an axle of the wheel assembly 152 of the wheelchair. Generally, the first sprocket 110 can be operatively coupled to the wheel assembly 152 axle. As such, when the first sprocket 110 is rotated, the wheel assembly 152 can be rotated.

Generally, the second sprocket 112 can be coupled to the crank 116 and the extension rod 118. As shown, the extension rod 118 can be implemented to elevate the second sprocket 112. The chain 114 can operatively couple the first sprocket 110 to the second sprocket 118. To rotate the second sprocket 112, the crank 116 can be operatively coupled to the second sprocket 112. When a user rotates the crank 116, the second sprocket 112 can be rotated, which in turn rotates the first sprocket 110. In one embodiment, a chain tensioner can be implemented to keep the chain 114 tight.

In one embodiment, the extension rod 118 can be adjustable in height. For instance, a user can adjust a height of the crank 116 by adjusting a height of the extension rod 118. Generally, the crank 116 can include a handle 117 for a user to grab. In one embodiment, as shown in FIG. 1A, the drive mechanism 102 can include a chain guard 119 for the chain 114. The chain guard 119 can generally be implemented to protect a user from the chain 114 while using the drive mechanism 102.

In an exemplary embodiment, the first sprocket 110 can have 48 cogs and the second sprocket 112 can have 24 cogs. It is to be appreciated that the number of cogs on each sprocket can be increased and/or decreased without exceeding a scope of the present invention. Generally, the first sprocket 110 can have more cogs and a larger diameter than the second sprocket 112.

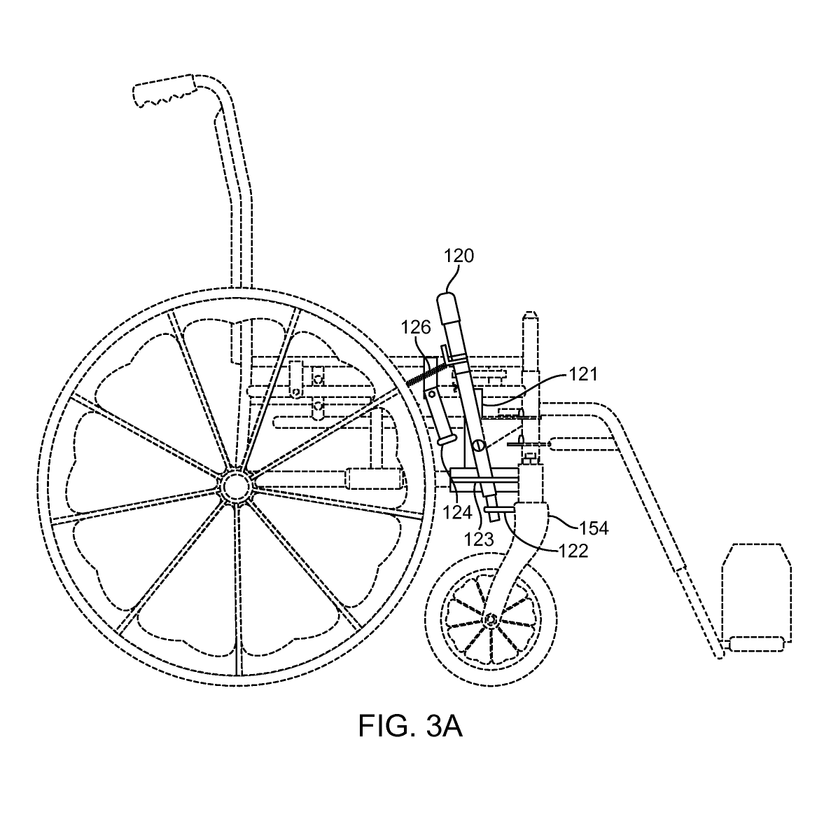

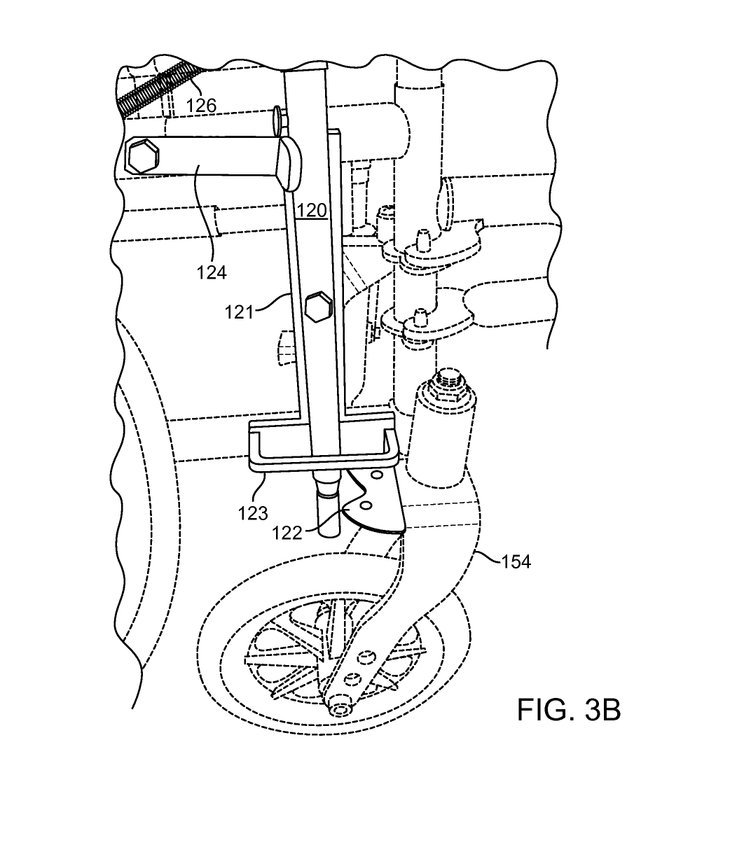

Referring to FIGS. 3A and 3B, detailed diagrams of the locking mechanism 104 are illustrated. Generally, the locking mechanism 104 can include a first lever 120, a plate 122, a second lever 124, and a spring 126. In some embodiments, the locking mechanism 104 can include a mount 121 and a slot 123. Generally, the mount 121 and the slot 123 can be combined together.

As shown generally in FIGS. 3A and 3B, the first lever 120 can be rotatably coupled to a right side of the wheelchair 150. In one embodiment, the mount 121 can be implemented to rotatably couple the first lever 120 to the wheelchair 150. For instance, the mount 121 can be coupled between two sections of a frame of the wheelchair 150. The first lever 120 can then be rotatably coupled to the mount 121. For instance, proximate a middle section of the first lever 120, a bolt can be threaded through the first lever 120 and the mount 121 with a nut to fasten the first lever 120 to the mount 121. Generally, bolts and nuts can be implemented to secure the mount 121 to the wheelchair 150. It is to be appreciated that other fasteners can be implemented to secure the mount 121 to the wheelchair 150 and the first lever 120 to the mount 121.

Generally, one end of the spring 126 can be coupled to the wheelchair 150 and another end can be coupled to an upper portion of the first lever 120. The spring 126 can be implemented to continuously pull the upper portion of the first lever 120, rotating a lower portion of the first lever 120 to engage the plate 122. In one embodiment, the spring 126 can be a compression spring. The slot 123 can generally be implemented to restrict the movement of the lever 120. For instance, the slot 123 can be implemented to keep the lever 120 from making a complete rotation. In one embodiment, the slot 123 can be combined with the mount 121. For instance, the slot 123 can be welded to the mount 121.

The first lever 120 can be implemented to engage the plate 122. In one embodiment, the plate 122 can be removably coupled to a castor 154 of the wheelchair. When the first lever 120 is engaged with the plate 122, as shown in FIG. 3B, the castor 154 can be locked in a substantially straight position. For instance, when a user rotates the crank 116 to propel the wheelchair 150 forward, the wheelchair 150 can move in a substantially straight line. Generally, the first lever 120 can move between a first position and a second position. In one instance, the first position can be when the first lever 120 is engaged with the plate 122, as shown in FIG. 3A. As shown in FIG. 3B, the second position can be when the first lever 120 is not engaged with the plate 122. Generally, when the first lever 120 is in the second position, the castor can rotate freely.

Typically, the second lever 124 can be implemented as a locking lever to stop the first lever 120 from engaging the plate 122, as shown in FIG. 3B. Generally, the user can rotate the first lever 120 forward and engage the locking lever 124 to allow the castor to rotate freely. When the locking lever 124 is engaged, the wheelchair user can make turns and operate the wheelchair in a normal fashion.

### An Example Implementation of a Wheelchair Bowling Kit

In a typical implementation, the components of the drive mechanism 102 and the locking mechanism 104 can be retrofitted to a wheelchair. Generally, a user can determine which side of the wheelchair to attach the drive mechanism 102 to based on a dominant hand of the user. For instance, if a right hand is the dominant hand, the drive mechanism 102 can be attached to a left side of the wheelchair. It is to be appreciated that the locking mechanism 104 can generally be attached to the opposite side of the wheelchair in respect to the drive mechanism 102.

After the user has determined which side to attach the mechanisms 102, 104, the user can proceed with attaching each component of the mechanisms 102, 104 to the wheelchair.

In a typical implementation, the drive mechanism 102 can be attached component by component to a wheelchair. The first sprocket 110 can generally be operatively coupled to an axle of a wheel assembly of the wheelchair. For instance, the wheel assembly can be removed from the chair and the first sprocket 110 can be coupled to the axle of the wheel assembly, and then the wheel assembly can be reattached to the wheelchair. The extension rod 118 can generally be inserted into a vertical frame portion of the wheelchair. For instance, many wheelchairs include vertical portions in the front of the frame of the wheelchair. In one embodiment, a fastener can be implemented to secure the extension rod 118 in place. Typically, the second sprocket 112 can be coupled to an upper portion of the extension rod 118. In some embodiments, the second sprocket 112 can be removably coupled to the extension rod 118. For instance, the second sprocket 112 can include a sleeve that slips over the extension rod 118 and can be tightened to secure the second sprocket 112 to the extension rod 118. In one embodiment, the second sprocket 112 can be more permanently coupled to the extension rod 118. For instance, the second sprocket 112 can be welded to the extension rod 118. The crank 116 and the handle 117 can generally be removably coupled to the second sprocket 112 by threaded fasteners. For instance, bolts and nuts can be implemented to secure the crank 116 to the second sprocket 112. The chain 114 can generally be operatively coupled to the first sprocket 110 and the second sprocket 112 after the sprockets are coupled to the wheelchair.

Similar to the drive mechanism 102, the locking mechanism 104 can be attached to the wheelchair component by component. Depending on how the wheelchair is constructed, the first lever 120 can be rotatably coupled to the wheelchair. For instance, a bolt and nut can be implemented to secure the first lever 120 to the wheelchair. For wheelchairs not having a suitable attachment location for the first lever 120, the mount 121 can be secured between two frame sections of the wheelchair, as generally shown in FIG. 3B. Generally, the mount 121 can be manufactured from a rigid material including, but not limited to, steel, aluminum, and other rigid materials. The first lever 120 can then be rotatably coupled to mount 121. Typically, the plate 122 can be removably coupled to a castor of the wheelchair. For instance, the plate 122 can be adapted to be coupled to a swivel joint of the castor, and then reattached to the wheelchair. It is to be appreciated that castors are well known in the art. Typically, the second lever 124 and the spring 126 can be coupled to the wheelchair with bolts and nuts. It is to be appreciated that other types of couplings can be implemented to secure the components of the locking mechanism 104 to a wheelchair without exceeding a scope of the present invention. For instance, couplings adapted to secure objects to tubes can be implemented including, but not limited to, hose clamps and wire clamps.

In one embodiment, a wheel on the side the locking mechanism 104 is to be attached to, can be moved in closer to a frame of the wheelchair before or after the mechanism 102, 104 are attached. For instance, most wheelchairs include one or more spacers between the wheel and frame of the wheelchair. The spacers can be removed to move the wheel in closer to the frame of the wheelchair.

### An Embodiment of a Bowling Wheelchair

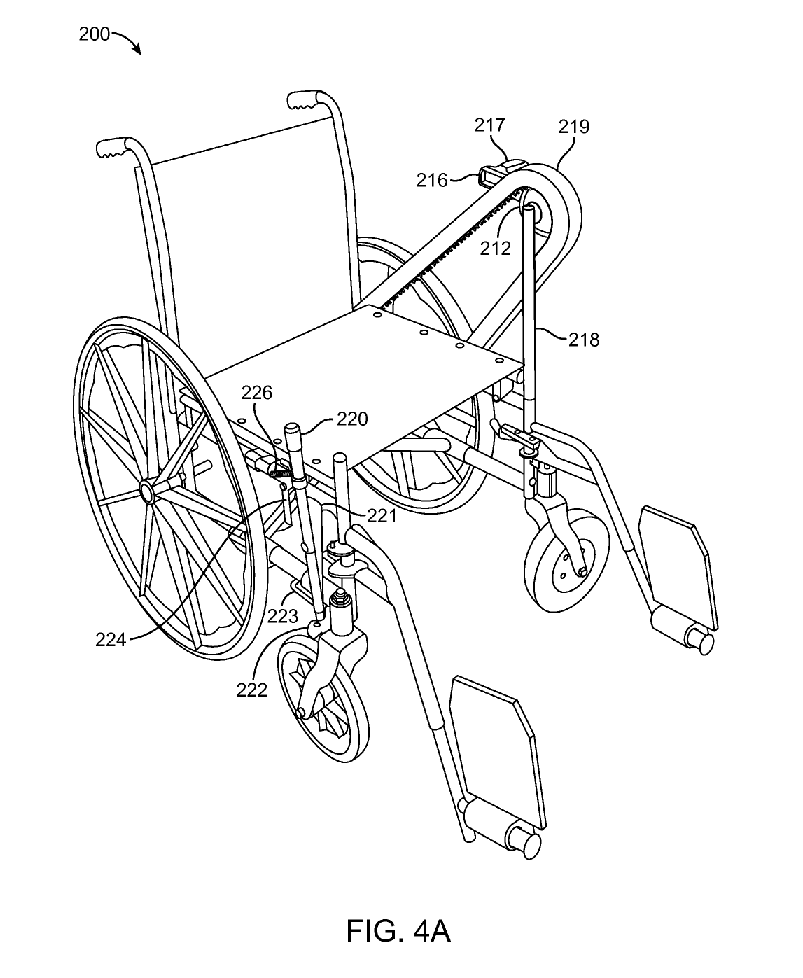

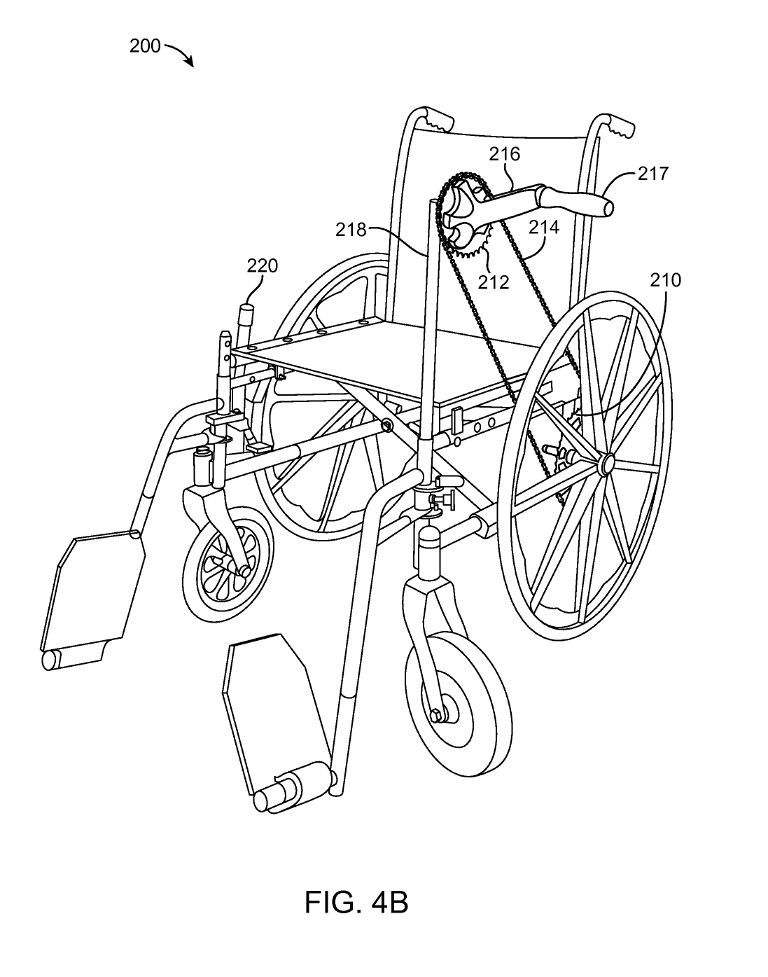

Referring to FIGS. 4A and 4B, a detailed diagram of an embodiment 200 showing a bowling wheelchair is illustrated. The bowling wheelchair 200 can generally be used by handicapped bowlers to bowl more conventionally.

As shown in FIGS. 4A and 4B, the bowling wheelchair 200 can be substantially similar to a wheelchair implementing the wheelchair bowling kit 100. For instance, the bowling wheelchair 200 can include components 206-226 similar to the drive mechanism 102, as shown in FIG. 4B, and the locking mechanism 104, as shown in FIG. 4A.

Generally, the components 206-226 of the bowling wheelchair 200 can be built as part of the bowling wheelchair 200 instead of being add-ons. The components 206-226 of the bowling wheelchair 200 can operate substantially similar to the components of the wheelchair bowling kit 100. Generally, the components 206-226 of the bowling wheelchair 200 can be fabricated as part of the wheelchair. For instance, a front castor of the bowling wheelchair 200 can include a plate 222 welded to the castor. In another instance, an extension rod 218 of the bowling wheelchair 200 can be fabricated integrally as part of the wheelchair. In yet another instance, the components 220-226, similar to the locking mechanism 104 of the wheelchair bowling kit 100, can be fabricated integrally as part of the wheelchair. For example, the components 220-226 can be built as part of the wheelchair.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A kit comprising:
a drive mechanism adapted to be operatively coupled to a wheelchair; and
a locking mechanism adapted to be operatively coupled to the wheelchair;
wherein the drive mechanism includes:
a crank;
a first sprocket operatively coupled to the crank;
a second sprocket operatively coupled to the first sprocket and adapted to be operatively coupled to the wheelchair;
an extension rod adapted to be coupled to the wheelchair and the first sprocket; and
a chain adapted to operatively couple the first sprocket to the second sprocket;
wherein the locking mechanism includes:
a lever adapted to be rotatably coupled to the wheelchair; and
a plate adapted to be coupled to a castor of the wheelchair, wherein the plate includes a groove adapted to receive an end of the lever.

2. The kit of claim 1, wherein the drive mechanism is adapted to propel the wheelchair forward and backward.

3. The kit of claim 1, wherein the locking mechanism is adapted to stop the castor of the wheelchair from rotating.

4. The kit of claim 1, wherein the locking mechanism further includes:
a spring adapted to be coupled to (i) the lever and (ii) the wheelchair; and
a locking bar adapted to be rotatably coupled to the wheelchair, wherein the locking bar is adapted to engage the lever.

5. The kit of claim 4, wherein the spring is a compression spring.

6. The kit of claim 1, wherein the extension rod is adjustable in length.

7. The kit of claim 1, wherein the crank includes a handle.

8. The kit of claim 1, wherein the plate is removably coupled to the castor.

9. The kit of claim 8, wherein the lever rotates from a first position to a second position.

10. The kit of claim 9, wherein the lever (i) engages the plate in the first position and (ii) is disengaged from the plate in the second position.

11. A combination comprising:
a wheelchair; and
the kit of claim 1.

12. A bowling wheelchair comprising:
a wheelchair;
a drive mechanism operatively coupled to the wheelchair, the drive mechanism including:
a crank;
a first sprocket operatively coupled to the crank;
a second sprocket operatively coupled to (i) a wheel assembly of the wheelchair and (ii) the first sprocket;
an extension rod coupled to the wheelchair and the first sprocket; and
a chain operatively coupling the first sprocket to the second sprocket;
a locking mechanism operatively coupled to the wheelchair, the locking mechanism including:
a lever rotatably coupled to the wheelchair; and
a plate coupled to a castor of the wheelchair, wherein the plate includes a groove adapted to receive an end of the lever.

13. The bowling wheelchair of claim 12, wherein the locking mechanism further includes:
a spring operatively coupled to (i) the lever and (ii) the wheelchair; and
a locking bar rotatably coupled to the wheelchair, wherein the locking bar is adapted to engage the lever.

14. The bowling wheelchair of claim 12, wherein (i) the drive mechanism is located on a left side of the wheelchair and (ii) the locking mechanism is located on a right side of the wheelchair.

15. The bowling wheelchair of claim 12, wherein (i) the drive mechanism is located on a right side of the wheelchair and (ii) the locking mechanism is located on a left side of the wheelchair.

16. The bowling wheelchair of claim 12, wherein the plate is welded to the castor.

17. The bowling wheelchair of claim 12, wherein the lever rotates from a first position to a second position.

18. The bowling wheelchair of claim 17, wherein the lever (i) engages the plate in the first position and (ii) is disengaged from the plate in the second position.

19. The bowling wheelchair of claim 18, wherein the castor does not rotate when the lever is in the first position.

20. A wheelchair kit comprising:
a locking mechanism adapted to be operatively coupled to a castor of a wheelchair, wherein the locking mechanism is adapted to keep the castor from rotating; and
a drive mechanism including:
a crank;
a first sprocket operatively coupled to the crank;
a second sprocket operatively coupled to the first sprocket and adapted to be operatively coupled to a wheelchair;
an extension rod adapted to be coupled to the wheelchair and the first sprocket; and
a chain adapted to operatively couple the first sprocket to the second sprocket.
